(19) United States
(12) Patent Application Publication
(10) Pub. No.: US 2010/0216346 A1
(43) Pub. Date: Aug. 26, 2010

(54) MULTIPOLE MATRIX CONNECTOR

(75) Inventors: Andreas Schmuckle, Flein (DE); Matthias Kassner, Heilbronn (DE); Uwe Ellsasser, Bietigheim-Bissingen (DE); Eckhard Schewe, Heilbronn (DE)

Correspondence Address: BLANK ROME LLP, WATERGATE, 600 NEW HAMPSHIRE AVENUE, N.W., WASHINGTON, DC, 20037, US

(73) Assignee: AMPHENOL-TUCHEL ELECTRONICS GMBH, Heilbronn (DE)

(21) Appl. No.: 12/676,080

(22) PCT Filed: Sep. 23, 2008
(86) PCT No.: PCT/EP08/08042

§ 371 Date: May 4, 2010

(30) Foreign Application Priority Data
Sep. 26, 2007 (DE) 1 02007 045 903.5

(51) Int. Cl. H01R 33/00

(52) U.S. Cl. 439/638

(57) ABSTRACT

The invention concerns a matrix connector comprising a first pair of plug-in connectors and a second pair of plug-in connectors, in which the first pair of plug-in connectors has a housing, in which at least one flexible printed circuit board with at least one array of contacts is designed, which is contacted with at least one second array of contacts, which is designed in the second pair of plug-in connectors.

The invention concerns a matrix connector and in particular a multipole matrix connector, according to the preamble of claim 1.

The invention concerns a matrix connector with an integrated flexible printed circuit board which has an array of contacts. The connector in the present invention thus comprises a matrix connector pair with a first matrix connector with a first flexible printed circuit board and a first array of contacts and a second pair of plug-in connectors with a second printed circuit board and second array of contacts, which is correspondingly formed to the first array of contacts and which can contact this.

The invention thus concerns a detachable matrix connector for contactable connection of printed circuit boards, and In particular flexible printed circuit boards.

In the state of the art matrix connectors with multipole contact configurations already known with contact arrays which are flat and are formed so as to mutually correspond.

For example, CA 2 490 096 shows a matrix connector constructed from a first array of contacts with formed connection pins and a second matrix with contact holes, into which the matrix connector can immerse with the connection pins, for detachable connections and for contact with a second matrix connector, in other words the matrix box connector.

In DE 3 215 191 an arrays of contacts is revealed in which contacts between the array of contact fields, or its contact sites, which are formed as open contacts sites, can be connected with a bridging die to corresponding contact sites, essentially by a key operation, so that current paths can be produced, through local and punctiform connection of different contact points of the array of contacts with the corresponding contact sites. This layout forms the basis of the peculiarity that the array of contacts is arranged with open contact sites in a flexible connecting cable and that this does not have to be immersed in the corresponding contact arrangement.

In the state of the art other similar contact arrangements are known, which all have the problem that with the increasing number of contacts in a matrix connector, and particularly with immersed contacts, the contact forces increase substantially and through this the plug-in and pulling-out forces are negatively influenced in such a matrix connector.

A further disadvantage of such matrix connectors is the problem of the tolerances and thus the position of the corresponding contact pair in the respective opposite array of contacts. If the corresponding contacts are not correctly aligned with each other, there will either be no contact, or the matrix connector cannot be operated and plugged in. Also the manufacturing tolerances still result in increased plug-in and pulling-out forces. A further disadvantage of the known matrix connectors is that the normal force of the contact over the whole contact field cannot be arbitrarily adjusted.

It is thus task of the present invention to supply a matrix connector in such a manner that the normal forces of the contact are scalable and adjustable, while at the same time the contacting is improved and higher contact security is achieved.

The task is achieved in the present invention by providing a matrix connector in which flexible printed circuit boards are integrated, each of which has an array of contacts that can be connected by touching a corresponding array of contacts in the mating connector, in which in one of the pair of plug-in connectors of the matrix connector the flexible printed circuit board is integrated into spring-loaded housing inserts. The housing inserts have guide pins which accomplish the alignment of the matrix connector and particularly the array of contacts with the corresponding array of contacts. These housing inserts are inserted into a further housing with spring-loading, in which further guiding device is present for alignment of the housing inserts for the corresponding matrix connector and thus the corresponding array of contacts. The multipole matrix connector in the present invention thus comprises a pair of plug-in connectors, a first connector, which flexibly accommodates the housing inserts and the flexible printed circuit boards with their array of contacts mounted inside, and a corresponding matrix connector, comprising a further pair of printed circuit boards, preferably flexible printed circuit boards and a guiding device, which fits into the corresponding guiding device of the housing in the first matrix connector pair.

Thus the connector, or on other words the matrix connector has first guiding devices which ensure that the array of contact fields of the pair of plug-in connectors in the multipole matrix connector are aligned to each other and a second guiding device, which ensures that the housings of the matrix connector pair are also aligned with each other. By arrangement of different arrays of contacts in this multipole matrix connector, a variety of arrays of contacts can be produced with flexible printed circuit boards, which due to their spring-loaded casing inserts can be impinged with varying contact spring forces.

The multipole matrix connector in the present invention is particularly suitable for applications in ultrasonic technology and for contacting and production of pictures in the ultrasonic process. In order to improve the contact security in the plugged-in state of the matrix connector pair in the present invention, the guiding device can be so formed that it includes a coding and a lock. Preferably the housing inserts are designed with helical springs, particularly with several helical springs, so that a stable spring force is achieved, which is thus distributed over the dimensions housing inserts. In an advantageous extension of the invention, the flexible conducting paths are bound to the housing inserts in several suitable places particularly with pass bands and held firmly in their place. Preferably besides the pass bands, essentially helical connections are further affixed on the flexible printed circuit board elements to join these with the housing inserts.

In another advantageous design of the matrix connector in the present invention the housing inserts include several guide ribs on the sides, which additionally contribute to the exact alignment of the arrays of contacts. Further advantages and appropriate construction of the invention are explained in the further claims of the description of the figures and the drawing. Shown are:

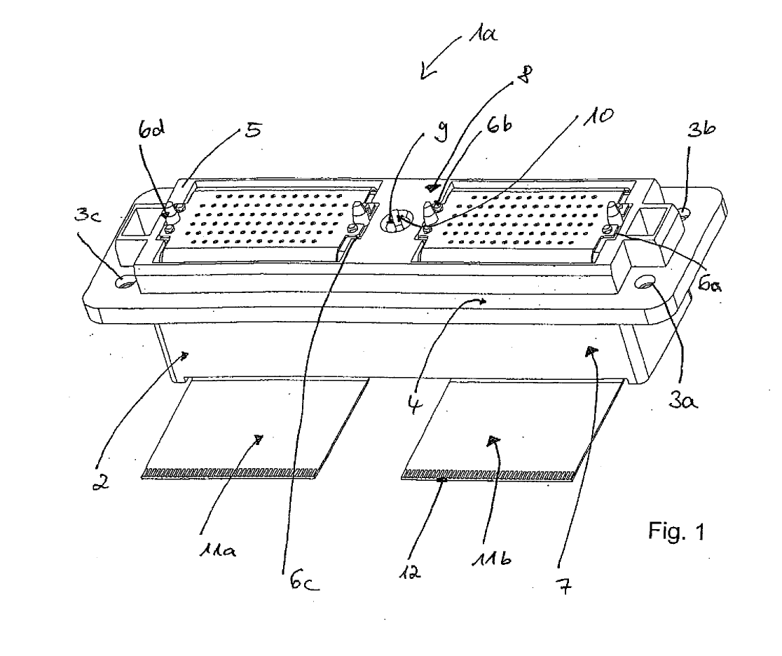

FIG. 1a perspective view of part of the matrix connector with mounted flexible conducting paths, which each include an array of contacts,

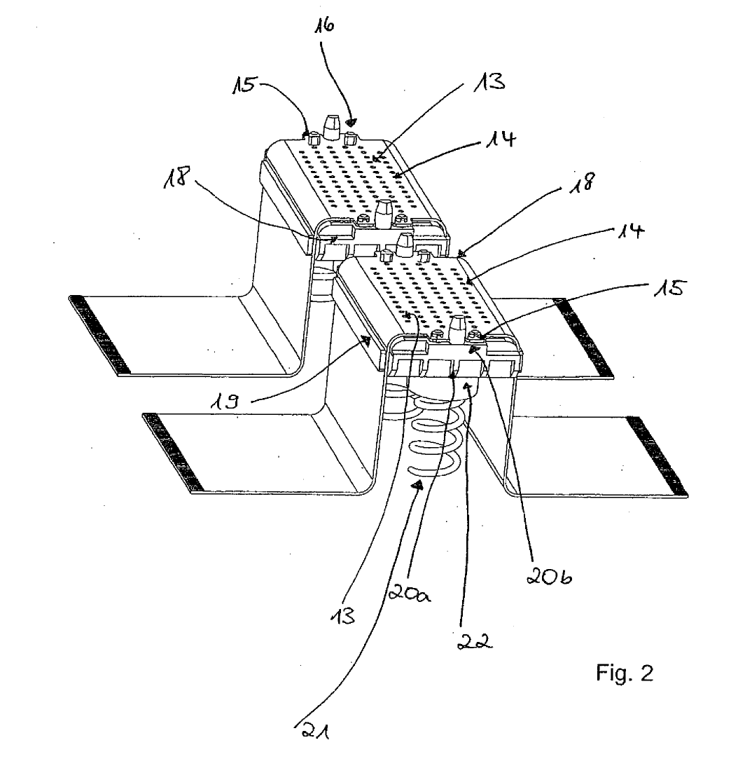

FIG. 2a slightly rotated perspective view of FIG. 1 of the flexible conducting paths and spring-loaded housing inserts shown in FIG. 1,

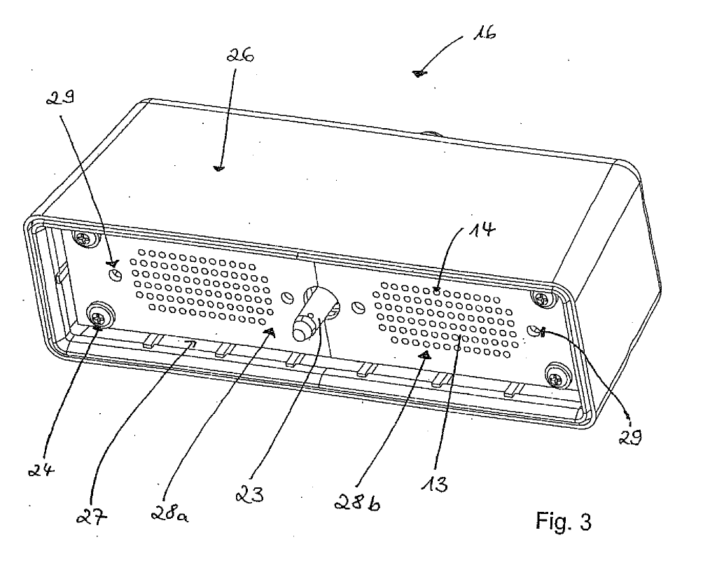

FIG. 3a perspective view of the matrix connector element corresponding to FIG. 1.

The essentially corresponding characteristics of the matrix connector are labelled in all figures with the same reference characters. Similar characteristics are labelled with the same reference signs, but provided additionally with small letters; different characteristics are labelled with different reference characters.

The present invention concerns a matrix connector 1 and in particular a multipole matrix connector. Connectors are generically built up of two plug-in parts, of which a first part is designed as free connector, as shown in FIG. 3, and a second designed as a mounted connector, for mounting on the housing, as shown in FIG. 1. Such pairs of plug-in connectors are generally referred to as connectors or in the present case as matrix connectors. The matrix connector according to the present invention is described in its parts as follows.

Matrix connector (mounted connector)

FIG. 1 shows the multipole matrix connector in the present invention respectively a part of the multipole matrix connector in the present invention 1, surrounded by a mounted housing 2. The mounted housing 2 is essentially so designed that it includes a housing flange 4 which is essentially designed flat and protrudes over the contour of the mounted housing 2. In this way such a matrix connector 1 can be inserted into an appropriate housing hole of an instrument or housing not shown. The housing flange 4 further includes in its corners mounting holes 3a, 3b, 3c, 3d, which serve to insert mounted housings with the array of contacts 13 inside into the provided housing hole and to firmly fix this with the mounting holes. Furthermore the mounted housing 2 includes a surrounding chamber wall 7 protruding out of the flange, which on the one hand is circumferentially closed and on the other hand is connected in its middle with a bridge 8. The chamber wall 7 is so designed on the mounted housing 2, that holes are formed for accommodating housing inserts 18, on the one hand from the chamber wall 7 and on the other hand from the bridge 8, and from the side walls of the mounted housing 2, which extend over the whole height of the mounted housing. In the bridge 8 and in the lateral sections of the chamber wall 7 are recesses 6a, 6b, 6c, 6d, which serve to position a housing insert in a given orientation, which is in addition suitable to be accommodated in the mounted housing 2. The multipole matrix connector in the present invention 1 includes inserted housing inserts 18 besides the mounted housing 2, which in their dimensions are tailored to the holes in the mounted housing and the accommodations 5 inside in the recesses 6a, 6b, 6c, 6d.

As further shown in FIG. 1, the bridge 8 includes a guide hole 9, in which there is in turn a groove 10 at the level of the bridge 8. This guide hole 9 serves amongst other things to correctly position the part of the matrix connector shown in FIG. 3 with the mounted housing, which then causes the contacts, which are correspondingly arranged with each other, to be correctly aligned in their position. In the mounted housing 2, as shown in FIG. 1, are mounted the arrays of contacts 13, which are part of the flexible printed circuit boards 11a, 11b. The arrays of contacts 13 include a variety of contact elements 14 arranged in a fixed grid, which is located on the surface of the flexible printed circuit boards 11a, 11b. As clearly shown in FIG. 2, the housing inserts 18 are assembled with the flexible printed circuit boards 11a, 11b in such a way, that the sections of the flexible printed circuit boards 11a, 11b, which include the array of contacts 13, are on the top of the housing inserts 18, whereas the other part of the flexible printed circuit boards 11a, 11b are bent around the housing inserts, so that these can be inserted underneath in the mounted housing 2. In the present invention the housing inserts 18 include two laterally attached guide ribs 20a, 20b; however the guide ribs 20b are suitable for immerging into the recesses 6a, 6b, 6c, 6d of the mounted housing 2 and the guide ribs 20a, 20b can be additionally guided to further guide levels. Furthermore the housing inserts 18 include spring recesses 22, which are essentially circular, cylindrical spring recesses 22 extending downwards under the housing inserts 18, to accommodate the springs 21. Preferably two essentially symmetrically-designed spring accommodations 22 are designed on each housing insert 18, which each accommodate one spring 21. The spring 21 is inserted on one end into the spring recess 22 and can be supported on the other end at a suitable point, which for example can be provided by a contour in the housing. If the housing inserts with the mounted flexible printed circuit boards 11a, 11b from FIG. 2 are inserted in the housing from FIG. 1, then these are flexibly mounted and can be cushioned along a defined path in the recesses 6a, 6b, 6c, 6d. This ensures, that in the plugged-in state, where the matrix connector 1 in FIG. 1 is plugged together with matrix connector 25 in FIG. 2, the normal force of the contact is applied that is necessary for contacting the contact elements 14 of the corresponding array of contacts 13. Through a suitable choice of the springs 21, according to the present invention, the spring tension and thus the contact pressing force of such a matrix connector can be defined precisely and aligned to the given application. In particular through increasing the number of the contact elements 14 in the array of contacts 13, the contact characteristics of such a multipole matrix connector can be optimised and improved by increasing the spring tensions of the springs 21.

For holding the flexible printed circuit boards 11a, 11b to the housing inserts 18 better, a pass band 19 is provided above the flexible printed circuit boards 11a, 11b and connected to the housing inserts 18. Thus the flexible printed circuit board lying between the pass band 19 and the housing insert 18, or respectively the printed circuit board section lying between these, is pressed with a defined force and secured against slipping or shifting. For further positioning and alignment of the flexible printed circuit board in the multipole matrix connector 1, lugs 15 are laterally mounted on the respective flexible printed circuit boards 11a, 11b, which in turn are interrupted by an essential U-shaped opening for the projecting through of further guiding devices 23. The lugs 15 are connected with the housing insert 18 with a connecting device 16, preferably with screws. Thus in connection with the above-mentioned pass bands 19, an exact position of the flexible printed circuit boards 11a, 11b in relation to the housing insert 18 can be defined and specified. The guiding devices 23, which are mounted on the sides of the housing inserts 18, serve in turn for the correct and exact alignment of the housing inserts 18, with regard to the mounted housing 2 and thus to the matrix connector pair 1b in FIG. 3 corresponding to the mounted housing 2. The guiding devices 23 are preferably designed as essentially cylindrical pins, which at their ends are somewhat pointed for guiding into the corresponding holes and thus for self-alignment of the connector in the connecting process. As is clearly visible particularly in FIG. 3, the matrix connector 1 with its second matrix connector part lb has a further guiding device 23, which is essentially positioned in the centre of the second matrix connector part lb. This guiding device 23 is also designed as an essentially cylindrical pin with a pointed end, and a bridge along the level of the pin, which can immerge into the guide hole 9 in the groove shown in FIG. 1. Thus it is ensured that the connector and particularly the matrix connector 1 shown here cannot be plugged in incorrectly, i.e. in a 180° twisted position. The groove 10 thus has a task to polarise and correctly align the second connector part 1b with the first connector part 1a, thus for the whole matrix connector 1. The second matrix connector part 1b includes a housing 26, in which the corresponding arrays of contacts 13 are mounted in a recess 27, thus set towards the back. These arrays of contacts can be designed as fixed, massive printed circuit boards, as shown here with a variety of contact elements 14, which lie on the surface of the circuit boards 28a, 28b or also can be replaced in a suitable manner by flexible printed circuit boards. In the printed circuit boards 28a, 28b are furthermore holes 29 designated which in their position correspondingly match with the guiding devices shown her in FIG. 1 or FIG. 2 respectively.

### LIST OF REFERENCE CHARACTERS

### Multipole Matrix Connector

1 Matrix connector
1a first pair of plug-in connectors
1b second pair of plug-in connectors
2 mounted housing
3a, b, c, d mounting holes
4 housing flange
5 accommodation
6a, b, c, d recesses
7 chamber wall
8 bridge
9 guide holes
10 groove
11a, b flexible printed circuit boards
12 conducting path connections
13 array of contacts
14 contact elements
15 lug
16 connecting device
18 housing inserts
19 pass band
20a, b guide ribs
21 spring
22 spring recess
23 further guiding devices
24 connecting device
26 housing
27 recess
28a, b printed circuit boards
29 holes

1. Matrix connector (1) comprising a first pair of plug-in connectors (1a) and a second pair of plug-in connectors (1b), in which the first pair of plug-in connectors (1a) has a housing (2), in which at least one flexible printed circuit board (11a, 11b) with at least one array of contacts (13) is designed, which is contacted with at least one second array of contacts (13), which is designed in the second pair of plug-in connectors (1b).

2. Matrix connector (1) according to claim 1, characterised in that the second array of contacts (13) of the seconds pair of plug-in connectors (1b) is constructed from a fixed printed circuit board (28a, 28b) and includes a variety of contact elements (14) in the array of contacts (13).

3. Matrix connector (1) according to claim 1, characterised in that the flexible printed circuit boards (11a, 11b) are firmly connected to housing inserts (18) flexibly mounted in the housing (2).

4. Matrix connector (1) according to claim 3 characterised in that the flexible printed circuit boards (11a, 11b) and the housing inserts (18) are connected together with connecting devices (15, 16).

5. Matrix connector (1) according to claim 3 characterised in that the flexible printed circuit boards (11a, 11b) include lugs (15) as connecting elements, which are connected to guide ribs (20b) on the housing inserts (18).

6. Matrix connector (1) according to claim 3 characterised in that the flexible printed circuit boards (11a, 11b) are connected to the side surfaces of the housing inserts (18) with pass bands (19).

7. Matrix connector (1) according to claim 3 characterised in that the housing inserts (18) have spring recesses (22) on their undersides.

8. Matrix connector (1) according to claim 3 characterised in that in the spring recesses (22) of the housing inserts (18) springs (21) are inserted.

9. Matrix connector (1) according to claim 3 characterised in that the housing inserts (18) are mounted flexibly in the housing (2) by means of the springs (21).

10. Matrix connector (1) according to claim 1 characterised in that the contact force between the matrices (13) of the first and second matrix connector pair (1a, 1b) is essentially created by the spring tension of the springs (21).

11. Matrix connector (1) according to claim 3 characterised in that the housing inserts (18) are made available via guiding devices (23) for correct finding of the corresponding arrays of contacts (13) of the first and second pair of plug-in connectors (1a, 1b).

12. Matrix connector (1) according to claim 1 characterised in that the mounted housing (2) has a guide hole (9).

13. Matrix connector (1) according to claim 12, characterised in that the guiding devices (23) protrude out of the housing (2) and the guide hole (9) immerges in the housing (2).

14. Matrix connector (1) according to claim 12 characterised in that the guide holes (9) have a groove (10).

15. Matrix connector (1) according to claim 12 characterised in that the second matrix connector pair (1b) include guiding devices (23), which when plugged into the first matrix connector pair (1a), immerge into the guide holes (9).

16. Matrix connector (1) according to claim 1 characterised in that the second matrix connector pair (1b) includes holes (29), which designed to correspond with the guides (23) of the first matrix connector pair (1a) and serve to orientate the contact elements (14) of the respectively corresponding array of contacts (13) with each other and to bring into a defined position when plugging the first matrix connector pair (1a) into the second matrix connector pair (1b).
